(19) United States
(12) Patent Application Publication
(10) Pub. No.: US 2014/0199511 A1
(43) Pub. Date: Jul. 17, 2014

(54) MODIFIED NANOPARTICLES, THEIR PREPARATION AND USE TO IMPROVE CATIONIC DYEABILITY OF FIBROUS SUBSTRATE

(71) Applicants: Fanliang Meng, Shanghai (CN); Xiaocong Shao, Shanghai (CN)

(72) Inventors: Fanliang Meng, Shanghai (CN); Xiaocong Shao, Shanghai (CN)

(73) Assignee: E I DU PONT DE NEMOURS AND COMPANY, Wilmington, DE (US)

(21) Appl. No.: 14/127,996

(22) PCT Filed: Jun. 22, 2012
(86) PCT No.: PCT/US12/43860

§ 371 Date: Feb. 25, 2014

(30) Foreign Application Priority Data
Jun. 23, 2011 (CN) 201110175679.4

(51) Int. Cl. D06M 15/233; C08F 112/08

(52) U.S. Cl. CPC D06M 15/233; C08F 112/08
USPC 428/87; 428/402; 428/327; 428/372; 525/342

(57) ABSTRACT

This invention relates to certain modified nanoparticles grafted with polymers comprise sulfonated benzene groups and preparation thereof. This invention also relates to certain polyester compositions comprising the modified nanoparticles, and their use to improve cationic dyeability of said polyester compositions.

This application claims the benefit of Chinese Patent Application No. 201110175679.4 filed June 23, 2011 which is herein incorporated by reference.

### FIELD OF THE INVENTION

The present invention relates to modified nanoparticles grafted with polymers comprising sulfonated benzene groups and preparation thereof. The invention also relates to certain polyester compositions comprising the modified nanoparticles, and the use of the modified nanoparticles to improve the cationic dyeability of said polyester compositions.

### BACKGROUND OF THE INVENTION

A synthetic fiber such as a polyester fiber is a polymer material, which has excellent mechanical properties and resistances to chemicals and environments, thereby usually being applied to fibers for clothes, industrial fibers, and films. However, even though it has some advantages, in the case of employing it as the fibers for clothes, since it has no functional groups interacting with cationic dyes, it can only be dyed using disperse dyes at a high temperature and pressure. Accordingly, many studies have been conducted to improve cationic dyeability of these synthetic fibers by copolymerization using ionic monomers or modified with ionic additives.

For imparting cationic dye dyeability, WO 99/09238 discloses a method of producing a copolyester dyeable by a cationic dye, in which 0.5-5 mol % of an ester-forming sulfonate compound (such as 5-sodium sulfonate dimethyl isophthalate) was added as the 3^{rd} monomer and which adopts a dimethyl terephthalate process. However, the production of copolyester is more complex and the manufacturing cost increases significantly. In addition, the mechanical and thermal properties of the copolyester are negatively affected by incorporating of the 5-sulfonyl isophthalate into the polymeric main chain.

Another method involves melt blending sulfonic compounds or its salts with a polyester polymer, e.g., 5-sodium sulfonate dimethyl isophthalate (for reference, see: E. M. Aizenshtein et al, Fibre Chemistry, 2000, 32, 187). However, this method is problematic in that these compounds tend to migrate to the surface of the fibrous polymer and can be easily washed away, which leads to diminished dyeability and durability. Additionally, these additives could also decompose during the high temperature compounding process.

Thus, there is a particular need for an additive having sulfonate groups that possess high processing stability. Through addition of said additive, polymeric compositions and fibers produced therefrom, particularly for polyester fibers, can attain cationic dyeability without surface migration or be easily washed off which are problems of known low molecular weight additives.

The present invention provide modified nanoparticles as additives providing advantages that include process ease and flexibility in loading to achieve balance with optimal cationic dye color and other mechanical properties. Moreover, due to the high molecular weight and high stability of the modified nanoparticles, there is no concern like surface migration or easily washed off problems.

JP3259444 (B2) discloses polyester films contain 0.1-10 weight % of inert particles including silicon oxide (average size 0.35 μm) or titanium oxide, which are surface coated with sulfonated styrene-maleic anhydride copolymer or sulfonated styrene-acrylate copolymer to improve the abrasion and scratch resistance of the films. The sulfonated copolymers are absorbed onto the inert particles by stirring the inert particles in a solution containing the copolymers and concentrated under reduced pressure. Thus, the copolymers are not covalently bonded to the inert particles.

Modified nanoparticles through covalently bonding with polystyrene and functional groups containing carboxyl groups are known. For example, CN101481444A discloses a

a modified SiO₂ particles prepared by bonding an atom transfer radical polymerization (ATRP) initiator onto SiO₂ particle surfaces by a silane coupling agent, grafting the SiO₂ particles with polystyrene by ATRP, and introducing carboxyl group onto the polystyrene-modified SiO₂ particle surfaces by click chemistry reaction.

Therefore, modified nanoparticles grafted with polymers (Le. covalently bonding) comprise sulfonated benzene groups are new. There is also a need to provide a method for preparing the modified nanoparticles.

### SUMMARY OF THE INVENTION

The present invention addresses the above by providing modified nanoparticles comprising nanoparticles grafted with at least one polymer, wherein the polymer comprises at least one sulfonated benzene group; the nanoparticles prior to being grafted with the polymer has an average diameter of about 100 nm or less; and the weight % of the at least one polymer ranges from about 30 weight % to about90 weight %, based on the total weight of the modified nanoparticles.

The invention also provides a method for preparing the modified nanoparticles disclosed herein comprising:
(a) providing nanoparticles having an average diameter of about 100 nm or less, and containing at least one epoxy, acrylate, or methacrylate group covalently bonded on the surface of nanoparticles;
(b) treating the nanoparticles of (a) with aromatic vinyl monomers which may or may not substituted with sulfonate group in the presence of a polymerization initiator to obtain polymer-grafted nanoparticles;
(c) treating the polymer-grafted nanoparticles of (b) with a sulfonating agent at 25-100° C. for 2-24 hours to obtain modified nanoparticles comprising at least one sulfonated benzene group;
(d) optionally, neutralizing the modified nanoparticles with base; and
(e) drying the modified nanoparticles in an oven at 25-100° C. for 6-24 hours.

### DETAILS OF THE INVENTION

All publications, patent applications, patents and other references mentioned herein, if not otherwise indicated, are explicitly incorporated by reference herein in their entirety for all purposes as if fully set forth.

Unless otherwise defined, all technical and scientific terms used herein have the same meaning as commonly understood by one of ordinary skill in the art to which this invention belongs. In case of conflict, the present specification, including definitions, will control.

Unless stated otherwise, all percentages, parts, ratios, etc., are by weight.

As used herein, the term “produced from” is synonymous to “comprising”. As used herein, the terms “comprises,” “comprising,” “includes,” “including,” “has,” “having,” “contains” or “containing,” or any other variation thereof, are intended to cover a non-exclusive inclusion. For example, a composition, process, method, article, or apparatus that comprises a list of elements is not necessarily limited to only those elements but may include other elements not expressly listed or inherent to such composition, process, method, article, or apparatus.

The transitional phrase “consisting of” excludes any element, step, or ingredient not specified. if in the claim, such a phrase would close the claim to the inclusion of materials other than those recited except for impurities ordinarily associated therewith. When the phrase “consisting of” appears in a clause of the body of a claim, rather than immediately following the preamble, it limits only the element set forth in that clause; other elements are not excluded from the claim as a whole.

The transitional phrase “consisting essentially of” is used to define a composition, method or apparatus that includes materials, steps, features, components, or elements, in addition to those literally discussed, provided that theses additional materials, steps features, components, or elements do not materially affect the basic and novel characteristic(s) of the claimed invention. The term “consisting essentially of” occupies a middle ground between “comprising” and “consisting of”.

The transitional phrase “essentially no” components or “essentially free” of components, it is meant that the compositions of the invention should contain less than 1% by weight, preferably less than 0.1 percent by weight, of the components, based on the total weight of the compositions.

The term “comprising” is intended to include embodiments encompassed by the terms “consisting essentially of” and “consisting of”. Similarly, the term “consisting essentially of” is intended to include embodiments encompassed by the term “consisting of”.

When an amount, concentration, or other value or parameter is given as either a range, preferred range or a list of upper preferable values and lower preferable values, this is to be understood as specifically disclosing all ranges formed from any pair of any upper range limit or preferred value and any lower range limit or preferred value, regardless of whether ranges are separately disclosed. For example, when a range of “1 to 5” is recited, the recited range should be construed as including ranges “1 to 4”, “1 to 3”, “1-2”, “1-2 & 4-5”, “1-3 & 5”, and the like. Where a range of numerical values is recited herein, unless otherwise stated, the range is intended to include the endpoints thereof, and all integers and fractions within the range.

When the term “about” is used in describing a value or an end-point of a range, the disclosure should be understood to include the specific value or end-point referred to.

Further, unless expressly stated to the contrary, “or” refers to an inclusive “or” and not to an exclusive “or”. For example, a condition A “or” B is satisfied by any one of the following: A is true (or present) and B is false (or not present), A is false (or not present) and B is true (or present), and both A and B are true (or present).

Also, the indefinite articles “a” and “an” preceding an element or component of the invention are intended to be nonrestrictive regarding the number of instances (i.e. occurrences) of the element or component. Therefore “a” or “an” should be read to include one or at least one, and the singular word form of the element or component also includes the plural unless the number is obviously meant to be singular.

In describing and/or claiming this invention, the term “homopolymer” refers to a polymer derived from polymerization of one species of monomer; “copolymer” refers to a polymer derived from polymerization of two or more species of monomers. Such copolymers include dipolymers, terpolyrners or higher order copolymers. The term “polymer” includes both homopolymer and copolymer unless specified, which may also worded as “(co)polymer”.

In describing certain polymers it should be understood that sometimes applicants are referring to the polymers by the monomers used to produce them or the amounts of the monomers used to produce the polymers. While such a description may not include the specific nomenclature used to describe the final polymer or may not contain product-by-process terminology, any such reference to monomers and amounts should be interpreted to mean that the polymer comprises those monomers (i.e. copolymerized units of those monomers) or that amount of the monomers, and the corresponding polymers and compositions thereof.

Embodiments of the present invention as described in the Summary of the Invention include any other embodiments described herein, can be combined in any manner, and the descriptions of variables in the embodiments pertain to the modified nanoparticles, compositions comprising said modified nanoparticles, and fibrous substrate made therefrom.

The invention is described in detail herein.

### Modified Nanoparticles

(a) Nanoparticles

Suitable nanoparticles may include inorganic particles having free hydroxy groups on the particle surfaces and are insoluble in water. By way of example, nanoparticles suitable for use in the invention may be selected from any of the following, including, but not limited to, silicon oxide (SiO₂); metal oxides such as aluminum oxide (Al₂O₃), antimony oxide (Sb₂O₃), cerium oxide (CeO₂), iron oxide (Fe₂O₃), lithium oxide (Li₂O), magnesium oxide (MgO), silver oxide (Ag₂O), tin oxide (SnO), titanium oxide (TiO₂), zinc oxide (ZnO), or zirconium oxide (ZrO₂); metal carbonates such as calcium carbonates (CaCO₃), or (MgCO₃); and combinations thereof. Preferred nanoparticles are selected from the group consisting of SiO₂, TiO₂, ZnO, CaCO₃, MgCO₃ and combinations thereof. Particular preferred nanoparticles are selected from the group consisting of SiO₂, TiO₂, ZnO and combinations thereof.

In describing and/or claiming this invention, the term “nanoparticle” is used in a broad sense, typically, as long as said particles having at least one of the dimensions is nanometric (10⁻⁹ meter) in scale. Though for illustrative purposes only, nanoparticles used in this invention have an average diameter of about 100 nm or less. Preferably, the average diameter is 1 nm to 80 nm; more preferably 10 nm to 70 nm; most preferably 20 nm to 50 nm.

With regards to the shape of the nanoparticles, an aspect ratio ranging between 1 and 1,000 is suitable; preferably, between 1 and 100; and more preferably, between 1 and 10.

Suitable nanoparticles, each having at least one free hydroxyl group on its surface, are typically treated with reactive functional group containing organosilanes to form covalently bonds (Si—O) between the Si atom of the organosilanes and O atom of the hydroxy group on the nanoparticles. The reactive functional group of the organosilanes can serve as the attachment points for subsequent grafting reaction. These organosilanes contain one or more reactive functional group such as epoxy, acrylate, methacrylate, and the like that may react with polymers and/or polymerizable monomers described herein. Suitable reactive functional group containing organosilanes include, for example, 3-methacryloxypropyl-trimethoxysilane, 3-acryloxypropyltrimethoxysilane, 3-methacryloxypropyltriethoxysilane, 3-acryloxypropyltriethoxysilane, 3-(glycidoxy)propyltrimethoxysilane, and 3-(glycidoxy)-propyltriethoxysilane. Preferably, the reactive functional group containing organosilanes are selected from the group consisting of 3-methacryloxypropyltrimethoxysilane, 3-acryloxy-propyltrimethoxysilane, and 3-(glycidoxy)propyltrimethoxysilane.

In an embodiment, in the modified nanoparticles of the present invention, the nanoparticles are treated with organosilanes selected from the group consisting of 3-methacryoxypropyltrimethoxysilane, 3-acryloxypropyltrimethoxysilane, 3-methacryloxy-propyltriethoxysilane, 3-acryloxypropyltriethoxysilane, 3-(glycidyloxy)propyltrimethoxy-silane, and 3-(glycidyloxy)propyltriethoxysilane. In another embodiment, in the modified nanoparticles of the present invention, the nanoparticles are treated with organosilanes selected from the group consisting of 3-methacryloxypropyltrimethoxysilane, 3-acryloxy-propyltrimethoxysilane, and 3-(glycidyloxy)propyltrimethoxysilane.

The organosilane-treated nanoparticles may be prepared by mixing the powdered nanoparticles and the organosilanes, followed with dehydration and drying. Alternatively, the organosilane-treated nanoparticles may be prepared by mixing the nanoparticles and the organosilanes in a solvent at room temperature, and a condensation reaction of the mixture at a temperature of about 40 to about 80° C. The solvent can include at least one of water and alcohols having 1 to 4 carbon atoms. The condensation reaction can be carried out for about 1 to about 6 hours.

Suitable organosilane-treated nanoparticles, including silicon oxide, zinc oxide and titanium oxide can also be purchased from commercial sources, for example, Hangzhou Wan Jing New Materials Co., Ltd., Shanghai Huijingya Nano Materials Co. Ltd, and Sachtleben Trading Shanghai Company Ltd.

(b) Polymer derived from aromatic vinyl monomer

As discussed above, according to some embodiments, the modified nanoparticles are grafted with at least one polymer comprises at least one sulfonated benzene group.

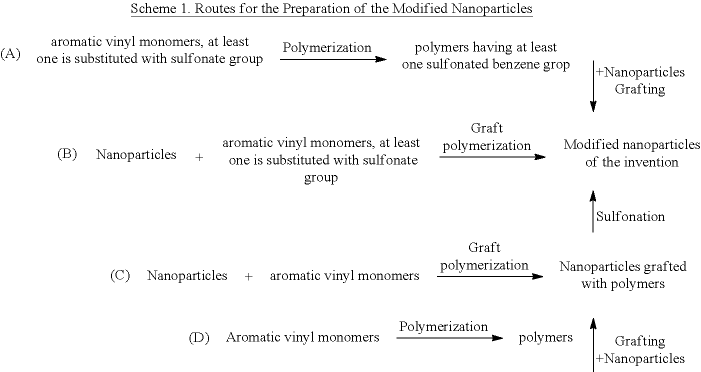

In certain embodiments, the polymer may be first prepared from aromatic vinyl monomers, and at least one of the aromatic vinyl monomers is substituted with a sulfonate group, then “grafted onto the nanoparticles” as shown in Scheme 1, Route (A), Alternatively, the polymer may be first prepared from one or more aromatic vinyl monomers without any sulfonate benzene group, grafted onto the nanoparticles, then sulfonated with suitable sulfonating reagent to obtain the inventive modified nanoparticles as shown in Scheme 1, Route (D). However, a “grafting onto the nanoparticles” method as depicted in Scheme 1, Route (A) or Route (D), inherently affords a low grafting density product; because it is difficult for a large polymer chain to diffuse to a nanoparticle surface, which is sterically hindered by surrounding bonded chains.

In contrast, a “grafting from the nanoparticles” method as depicted in

Scheme 1, Route (B) or Route (C), enables preparation of polymer-grafted nanoparticles with high grafting density due to avoidance of such sterically hindrance. The polymer can be formed directly by reacting the organosilane-treated nanoparticles with aromatic vinyl monomers by graft polymerization. When at least one of the aromatic vinyl monomers is substituted with a sulfonate group, then the inventive modified nanoparticles may be obtained directly (Route (B) of Scheme 1). When the graft polymerization uses only aromatic vinyl monomers having no sulfonate groups, then a sulfonation step is needed to obtain the inventive modified nanoparticles (i.e. following Route (C) of Scheme 1). Although, the inventive modified nanoparticles of high grafting density may be prepared by Route (B), an extra sulfonation step may still be employed to provide the modified nanoparticles with greater number of sulfonated benzene groups per unit weight.

In a preferred embodiment, the organosilane-treated nanoparticles may serve as seeds (or attachment points) during graft polymerization with the suitable aromatic vinyl monomers to afford polymer-grafted nanoparticles, wherein the aromatic vinyl monomers may or may not be substituted with sulfonate group. In another preferred embodiment, the polymer-grafted nanoparticles, which may or may not have at least one sulfonated benzene group, can be further sulfonated to provide the modified nanoparticles of the present invention.

Suitable aromatic vinyl monomer include, but are not limited to, styrene, □-methylstyrene, □-methylstyrene, o-methylstyrene, m-methylstyrene, p-methylstyrene, o-ethylstyrene, m-ethylstyrene, p-ethylstyrene, o-tert-butylstyrene, m-tert-butylstyrene, p-tert-butylstyrene, o-chlorostyrene, m-chlorostyrene, p-chlorostyrene, dichlorostyrene, o-bromostyrene, m-bromostyrene, p-bromostyrene, dibromostyrene, vinyl toluene, vinyl xylene, vinyl naphthalene, and divinylbenzene. Combinations of any of the foregoing monomers may also be used.

Suitable aromatic vinyl monomer substituted with sulfonate group includes, but are not limited to, 4-ethenylbenzenesulfonic acid, 4-ethenyl-3-ethylbenzenesulfonic acid, and sodium or potassium salts thereof. Preferably, the aromatic vinyl monomer substituted with sulfonate group is used in the charge neutral state, i.e. a sulfonate salt during the graft polymerization.

An additional monomer may be copolymerized with one or more of the above mentioned aromatic vinyl monomers. In some embodiments, this additional monomer can be a vinyl cyanide monomer, an acrylic monomer or an imide monomer that is copolymerizable with one or more of the above mentioned monomers.

Suitable vinyl cyanide monomers include, but are not limited to, acrylonitrile, methacrylonitrile, and ethacrylonitrile. Combinations of any of the foregoing monomers may also be used.

Suitable acrylic monomers include, but are not limited to, methacrylic acid esters such as methyl methacrylate, ethyl methacrylate, propyl methacrylate, butyl methacrylate, benzyl methacrylate; acrylic acid esters such as methyl acrylate, ethyl acrylate, propyl acrylate, n-butyl acrylate, 2-ethylhexyl acrylate; unsaturated carboxylic acids such as acrylic acid, methacrylic acid, maleic anhydride; acrylic acid esters containing hydroxy-group such as 2-hydroxyethylacrylate, 2-hydroxypropylacrylate, monoglycerol acrylate; and acrylic acid derivatives such as acrylamide, methacrylamide. The acrylic monomer may also be a combination of two or more acrylic monomers as described above.

Suitable imide monomers include, but are not limited to, maleimide, N-methyl maleimide, N-phenyl maleimide and acrylimide. The imide monomer may also be a combination of two or more imide monomers as described above.

In some embodiments, in the polymer-grafted nanoparticles, the polymers comprise about 50 to about 100 parts by weight of one or more aromatic vinyl monomers or combinations thereof, and about 0 to about 50 parts by weight of the vinyl cyanide monomer, the acrylic monomer, the imide monomer, or any combination thereof.

Preferably, the polymer-grafted nanoparticles comprise at least one polymer derived from aromatic vinyl monomers selected from the group consisting of styrene, □-methylstyrene, □-methylstyrene, o-methylstyrene, m-methylstyrene, p-methylstyrene, o-ethylstyrene, m-ethylstyrene, p-ethylstyrene, o-tert-butylstyrene, m-tert-butylstyrene, p-tert-butylstyrene, o-chlorostyrene, m-chlorostyrene, p-chlorostyrene, dichlorostyrene, o-bromostyrene, m-bromostyrene, p-bromostyrene, dibromostyrene, vinyl toluene, vinyl xylene, vinyl naphthalene, divinylbenzene, sodium 4-ethenylbenzenesulfonate, potassium 4-ethenylbenzenesulfonate, sodium 4-ethenyl-3-ethylbenzenesulfonate, potassium 4-ethenyl-3-ethylbenzenesulfonate, and combinations thereof; and has at least one sulfonated benzene group.

More preferably, the polymer-grafted nanoparticles comprise at least one polymer derived from aromatic vinyl monomers selecting from the group consisting of styrene, □-methylstyrene, □-methylstyrene, o-methylstyrene, m-methylstyrene, p-methylstyrene, vinyl toluene, vinyl xylene, vinyl naphthalene, divinylbenzene, sodium 4-ethenylbenzenesulfonate, potassium 4-ethenylbenzenesulfonate, and combinations thereof; and has at least one sulfonated benzene group.

Most preferably, the polymer-grafted nanoparticles comprise at least one polymer derived from aromatic vinyl monomers selecting from the group consisting of styrene, sodium 4-ethenylbenzenesulfonate, potassium 4-ethenylbenzenesulfonate, and combinations thereof; and has at least one sulfonated benzene group. In this case, the polymer-grafted nanoparticles comprise sulfonated polystyrenes.

Alternatively, the modified nanoparticles of this invention may derive from treating polymer-grafted nanoparticles with a sulfonating reagent. The chemical modification (i.e. sulfonation) of precursor polymers to produce charged polymers may be incomplete, and typically result in an average charge per repeat unit that is less than 1. The extent of sulfonation can be determined by acid-base titration. For best results, the sulfonated polymer-grafted nanoparticles are neutralized with aqueous or alcoholic solution of a base such as sodium hydroxide or potassium hydroxide.

Suitable sulfonating reagents include, but not limited to, fuming sulfuric acid, chlorosulfonic acid, acetic sulfuric anhydride, and benzenesulfonyl chloride.

In one embodiment, in the modified nanoparticles of the present invention, the at least one polymer is derived from aromatic vinyl monomers selected from the group consisting of styrene, sodium 4-ethenylbenzenesulfonate, potassium 4-ethenylbenzene-sulfonate, and combinations thereof.

In another embodiment, in the modified nanoparticles of the present invention, the at least one polymer is derived from treating the polymer-grafted nanoparticles with a sulfonating reagent selected from the group consisting of fuming sulfuric acid, chlorosulfonic acid, acetic sulfuric anhydride, and benzenesulfonyl chloride,

(c) Preparation of the Modified Nanoparticles

Another aspect of the invention is a method for preparing the modified nanoparticle grafted with at least one polymer, wherein the polymer comprises at least one sulfonated benzene group including the steps of: (a) providing nanoparticles having an average diameter of about 100 nm or less, and containing at least one epoxy, acrylate, or methacrylate group covalently bonded on the surface of nanoparticles; (b) treating the nanoparticles with aromatic vinyl monomers which may or may not substituted with sulfonate group in the presence of a polymerization initiator to obtain polymer-grafted nanoparticles; (c) treating the polymer-grafted nanoparticles of (b) with a sulfonating agent at 25-100° C. for 2-24 hours to obtain modified nanoparticles comprising at least one sulfonated benzene group; (d) optionally, neutralizing the modified nanoparticles with base; and (e) drying the modified nanoparticles in an oven at 25-100° C. for 6-24 hours.

Examples of polymerization initiators include, but are not limited to, acetyl cyclohexane sulfonyl peroxide, 2,2′-azobis(2,4-dimethylvaleronitrile), 2,2′-azobis-(2-amidinopropane) dihydrochloride, lauroyl peroxide, 2,2′-azobis(isobutyronitrile), benzoyl peroxide, dimethyl 2,2′-azobis(2-methylpropionate), 4,4′-azobis(4-cyanovaleric acid), potassium persulfate, sodium persulfate, and ammonium persulfate.

The polymerization initiator may be used in an amount of about 0.01 to about 10 weight % based on the total weight of the polymerizable composition, and preferably about 0.1 to about 5 weight %, based on the total weight of the polymerizable composition. As used herein, the polymerizable composition is the composition that results from removing the solvent from the mixture comprising organosilane-treated nanoparticles and aromatic vinyl monomers.

### Nanocomposite Compositions

A nanocomposite composition can be prepared through a process of kneading and extruding the modified nanoparticles of this invention and polyesters so that fibrous substrates made from the nanocomposite compositions with improved cationic dyeability can be prepared.

### Polyester

According to the present invention, the polyester constitutes any condensation polymerization products derived from, by esterification or transesterification, an alcohol and a dicarboxylic acid including an ester thereof.

Examples of such an alcohols include glycols having 2 to about 10 carbon atoms such as ethylene glycol, 1,2-propanediol, 1,3-propanediol, 1,3-butanediol, 1,4-butanediol, 1,5-pentanediol, neopentyl glycol, 1,6-hexanediol, diethylene glycol, triethylene glycol, polyethylene glycol, 1,2-, 1,3- and 1,4-cyclohexane dimethanol, and longer chain diols and polyols, such as polytetramethylether glycol, which are the reaction products of diols or polyols with alkylene oxides, or combinations of two or more thereof.

Examples of such a dicarboxylic acids include terephthalic acid, isophthalic acid, phthalic acid, succinic acid, glutaric acid, adipic acid, azelaic acid, sebacic acid, 1,4-cyclohexane dicarboxylic acid, 1,3-cyclohexane dicarboxylic acid, 1,12-dodecanedioic acid, and the derivatives thereof such as the dimethyl-, diethyl-, dipropyl esters of these dicarboxylic acids, or combinations of two or more thereof.

The polyester may be a homopolymer or a copolymer. When the copolymer is adopted, the copolymerizing dicarboxylic acid component constituting the copolymer may be aromatic dicarboxylic acids such as terephthalic acid, phthalic acid, 2,6-naphthalene dicarboxylic acid; aliphatic dicarboxylic acids such as adipic acid, azelaic acid, sebacic acid, and 1,12-dodecanedioic acid. Examples of the diol component include aliphatic diols such as ethylene glycol, 1,2-propanediol, 1,3-propanediol, 1,4-butanediol, neopentyl glycol and 1,6-hexanediol; and alicyclic diols such as 1,4-cyclohexane dimethanol. These compounds may be used either singly or in the form of a mixture of two or more compounds.

According to the invention, one of the preferred polyesters for the nanocomposite composition is selected from polyethylene terephthalate (PET), polytrimethylene terephthalate (PTT), polybutylene terephthalate (PBT), and combinations thereof.

PET is a polyester prepared by the condensation polymerization of ethylene glycol and terephthalic acid (or transesterification of ethylene glycol and dimethyl terephthalate). The PET may be a PET homopolymer or a copolymer that preferably contains 70 weight % or more of polyethylene terephthalate, or blends thereof. These may be modified with up to 30 weight % of polyesters made from other diols or diacids. The preferred polyester is a PET homopolymer.

PTT is a polyester that may be prepared by the condensation polymerization of 1,3-propanediol and terephthalic acid (or transesterification of 1,3-propanediol and dimethyl terephthalate). The 1,3-propanediol for use in making the PTT is preferably obtained biochemically from a renewable source (“biologically-derived” 1,3-propanediol). The PTT may be a homopolymer or a copolymer that preferably contains 70 weight % or more of PTT, or blends thereof. These may be modified with up to 30 weight % of polyesters made from other diols or diacids.

According to the invention, one of the preferred polyesters for the nanocomposite composition is selected from a PTT homopolymer or a PTT copolymer which contains 70 weight % or more of PTT. The more preferred polyester is a PTT homopolymer.

PBT is a polyester that may be prepared by the condensation polymerization of 1,4-butanediol and terephthalic acid (or transesterification of 1 ,4-butanediol and dimethyl terephthalate). The PBT may be a homopolymer or a copolymer that preferably contains 70 weight % or more of PBT, or blends thereof. These may be modified with up to 30 weight % of polyesters made from other diols or diacids. The preferred polyester is PBT homopolymer.

Because polyesters and processes for making them are we known to one skilled in the art, further description is omitted herein for the interest of brevity.

Suitable polyesters can be selected from commercial brands such as Petra® PET, Ultradur® PBT from BASF, Rynite® PET, Sorona® PIT, Crastin® PBT from DuPont, Polyclear® PET from Invista, and SKYPET® from SK Chemicals, Toraycon® PBT from Toray Industries, Inc.

The amount of polyester employed in the nanocomposite composition of the present invention ranges from about 90.0 to about 99.9 weight %, preferably from about 95.00 to about 99.5 weight %, and more preferably from about 97.00 to about 99.0 weight %, based on the total weight of the nanocomposite composition.

### Other Additives

The nanocomposite composition of the present invention may further comprise small amounts of optional additives commonly used and well known in the polymer art. Examples of additives include without limitation antioxidants, thermal stabilizers, ultraviolet light stabilizers, colorants including dyes and pigments, lubricants, surfactants, nucleating agents, coupling agents, hydrolysis resistants, antistatic agents, and flame retardants.

These additive(s) may be present in the nanocomposite compositions in quantities that are generally from about 0.01 to about 15 weight %, preferably from about 0.01 to about 10 weight %, so long as they do not detract from the basic and novel characteristics of the nanocomposite composition and do not significantly adversely affect the performance of the nanocomposite composition.

The nanocomposite compositions of the invention may be formed by techniques known in the art. The ingredients and optional additives are typically in powder or granular form, and extruded as a blend, and/or cutting into pellets or other suitable shapes. The ingredients may be combined in any manner, e.g., by dry mixing or by mixing in the melted state in an extruder, or in other mixers. For example, one embodiment comprises melt blending the ingredients in powder or granular form, extruding the blend and comminuting into pellets or other suitable shapes. The term “pellets” is used generically in this regard, and is used regardless of shape sometimes called “chips”, “flakes”, etc. Also included is dry mixing the ingredients, followed by mixing in the melted state in an extruder. The mixing temperatures should be above the melting points of each component, but below the lowest decomposition temperature, and accordingly must be adjusted for any particular nanocomposite composition of polyester and the modified nanoparticles. The mixing temperature is typically in the range of about 180° C. to about 290° C., preferably at least about 220° C. and more preferably up to about 260° C., depending on the particular polyester and the modified nanoparticles of the invention.

In the nanocomposite compositions of present invention, a nanocomposite structure is formed when the modified nanoparticles are substantially uniformly dispersed in a matrix of the polyester, and the nanocomposite structure can be confirmed by electron microscopes such as a TEM (transmission electron microscope) and an SEM (scanning electron microscope).

Because the primary objective is to perform dyeing of the fibrous substrates made from the nanocomposite composition using cationic dyes, it is better to limit the content of the modified nanoparticles in the nanocomposite composition or the polyester yarn made therefrom, from the perspective of spinning properties.

In one embodiment of the present invention, pellets may be manufactured by blending and extruding the nanocomposite composing comprising about 0.1 to about 10.0% by weight of the modified nanoparticles and about 90.0 to about 99.9% by weight of a polyester, at a temperature of about 180 to about 290° C.

The amount of the modified nanoparticles employed in the nanocomposite composition of the present invention ranges from about 0.1 to about 10.0 weight %, preferably from about 0.3 to about 5.0 weight %, more preferably from about 0.5 to about 3.0 weight %, based on the total weight of the nanocomposite composition.

### Fibrous Substrates Comprising Nanocomposite Compositions

The nanocomposite compositions of the invention can be readily converted into pellets, re-melted and spun into filaments, or used directly to the spinning/drawing process. The nanocomposite compositions can be spun into filaments for applications such as apparel, carpeting, and other applications where the filaments or fibrous substrates are needed, and can be prepared using conventional polymer and filament making equipment. As described elsewhere, the nanocomposite compositions of the invention provide improved cationic dyeability over the polyester itself.

For the purposes of this invention, the term “fibrous substrate” includes filaments, yarns, fabrics, textile, or finished product, used in garments, home furnishings, carpets, and other consumer products. There is no specific limitation of “fibrous substrate.” The fibrous substrate of the present invention may be “knitted”, “woven” or “nonwoven” substrates. Non-woven substrates may include substrates which fibers are a web or batt of fibers bound by the application of heat, entanglement, and/or pressure.

A particular preferred fibrous substrate of the invention includes filaments, yarns, fabrics, and carpets.

The filaments can be round or have other shapes, such as octalobal, delta, sunburst (also known as sol), scalloped oval, trilobal, tetra-channel (also known as quatra-channel), scalloped ribbon, ribbon, starburst, etc. They can be solid, hollow or multi-hollow, and are preferably solid.

A wide variety of filaments can be prepared according to the invention. Typically filaments for most uses, such as textile and carpet, have a size of at least about 0.5 dpf (denier per filament), and up to about 35 dpf. Monofilaments are larger and can be about 10 to about 2000 dpf.

The filaments of this invention can have crimp such as in the case of a bulked continuous yarn or textured yarn, but the advantages of this invention can be seen in uncrimped yarns such as partially oriented yarns, spun draw yarn or other uncrimped yarns, such as those used in many nonwovens.

These yarns, continuous yarn or textured yarn, are multifilament yarns. The yarns (also known as “bundles”) preferably comprise at least about 10 and even more preferably at least about 25 filaments; and typically can contain up to about 150 or more, preferably up to about 100, more preferably up to about 80 filaments. Yarns containing 34, 48, 68 or 72 filaments are common. The yarns typically have a total denier of at least about 5, preferably at least about 20, more preferably at least about 50; and up to about 1500, preferably up to about 250.

The partially oriented yarns, spun drawn yarns, and textured yarns are used to prepare textile fabrics, such as knitted and woven fabrics.

Bulked continuous filament yarns can be made into carpets using well-known techniques. Typically, a number of yarns are cable twisted together and heat set in a device such as an autoclave, SUESSEN or SUPERBA®, and then tufted into a primary backing. Latex adhesive and a secondary backing are then applied.

While the invention is primarily described with respect to multifilament yarns, it should be understood that the preferences described herein are applicable to managements. Monofilaments are used to make many different items, including brushes (e.g., paint brushes, tooth brushes, cosmetic brushes, etc.), fishing line, etc.

### Dyeing of Fibrous Substrates

There are no particular limitations upon the dyeing method. A continuous dyeing process may be used with a low bath ratio, or batch dyeing can be performed with a liquid reflux dyeing machine, wince dyeing machine, jigger dyeing machine, beam dyeing machine or cheese dyeing machine. Conventional print technology can also be used to print precision patterns on the fabrics.

In dyeing the polyester fiber or fabric made therefrom according to the present invention, the usual cationic dyes may be employed in the dyeing method. To with, the dye temperature should range between from 80 to 135° C., preferably between from 100 to 130° C., with the use of uniform dyeing agents, pH modifiers, bath softeners and the like. For example, in performing dyeing on a polyester fiber, 2-3 g/L of Glauber's salt (Na₂SO₄.10H₂O) should be added as a leveling agent. After dyeing, a surfactant can be employed in the wash process. There are no particular restrictions upon the dye types used for the dye colors or their chemical structure. There are two types of cationic dyes, the raw cationic dyes which have excellent color density, and the dispersion type cationic dyes which have excellent handling properties in the dyeing process. In actual fabric dyeing, a dispersion type cationic dye can be used with a plurality of dyes formulated together in a single bath without precipitation.

Without further elaboration, it is believed that one skilled in the art using the preceding description can utilize the present invention to its fullest extent. The following Examples are, therefore, to be construed as merely illustrative, and not limiting of the disclosure in any way whatsoever.

### EXAMPLES

The abbreviation “E” stands for “Example” and “CE” stands for “Comparative Example” is followed by a number indicating in which example the inventive nanoparticles or nanocomposite composition is prepared. The examples and comparative examples were all prepared and tested in a similar manner. Percentages are by weight unless otherwise indicated.

### Material

Chemical reagents of analytic pure grade including styrene (St), potassium persulfate (KPS), sulfuric acid (95-97%), sodium hydroxide, acetic anhydride, dichloroethane, 2-propanol, etc. were purchased from Sinopharm Chemical Reagent Co. Ltd., China.

Nanoparticles including silicon oxide, zinc oxide and titanium oxide (average diameter of 30 nm, treated with 2 weight % of 3-methacryloxypropyltrimethoxysilane in ethanol) were purchased from Hangzhou Wan Jing New Materials Co., Ltd.

PTT, also known as SORONA®, semidull grade, IV=1.02, was obtained from E.I. DuPont de Nemours and Company (Wilmington, Del., USA). IRGANOX® 1010 (CAS number 6683-19-8) is a phenolic based antioxidant, which was obtained from Ciba Specialty Chemicals.

In the Examples, the main measurement values and evaluation values were obtained by the following measuring methods and evaluation methods.

### Testing Instrumentation

Thermal gravimetric analysis (TGA) was carried out with a TA Q500 instrument at a heating rate of 20° C./min in a temperature of 35-800° C. under air atmosphere.

Scanning electron microscopy (SEM) and point-localized energy-dispersive X-ray spectroscopy (EDAX or EDS, model: NOVA200 132-10; accelerating voltage was 20 kV) were used to characterize the elemental composition of the modified nanoparticles.

Color® Primer 8000 spectrophotometer supplied by X-Rite, Inc. (USA) was used to measured the reflectance of the dyed samples in visible range (360-740 nm). The color coordinates were obtained under illuminant with pulsed Xenon light and 10° standard observer.

### Example 1

### Preparation of Modified Nano-Silicon Oxide Particles

### Step A. Grafting Polymerization on the Silicon Oxide Nanoparticles

Grafting polymerization was carried out in a 3 L three-necked round bottom flask equipped with a condenser and a mechanic stirrer. Deionized water (1700 mL), Z-propanol (40 g), 0.6 g of sodium dodecyl sulfate (SDS) and 0.3 g of phenyl polyethylene glycol ether (OP-10) were charged into the flask and stirred for 0.5 hour at room temperature under a nitrogen atmosphere. The silicon oxide nanoparticles (20 g) were dispersed in absolute ethanol (200 mL) by ultrasonication for 0.5 hr at room temperature, then added to the mixture in the reaction flask. The reaction mixture was heated to 75° C. with stirring at a rate about 220 rpm, then added a 1 wt % aqueous solution of potassium persulfate (KPS, 20 mL) dropwise over 10 minutes; followed by addition of distilled styrene (200 mL) through syringe pump for 2-2.5 hours at 75° C. The reaction temperature was raised to 80° C. and maintained stirring for another 2-5 hour to improve the grafting yield. The reaction mixture was cooled to room temperature and sit without stirring for overnight. Saturated sodium chloride solution (200 mL) was added to the reaction mixture to break the emulsion.

The precipitated mixture containing polystyrene-grafted nanoparticles and polystyrenes was isolated by centrifugation to remove the suspended mixture; rinsed with water for 3 times to remove inorganic materials, then placed in a vacuum oven to dry at 50° C. for about 5 hr.

The polystyrenes, i.e. not grafted onto nanoparticles, in the semi-moist precipitated mixture was extracted into toluene (about 500 mL) using a Soxhlet extractor. After decanted off the toluene, the polystyrene-grafted-silicon oxide (SiO₂-g-PS) particles were dried at 50° C. overnight under reduced pressure in a vacuum oven to obtain 34 g of white powder. A sample of polystyrene grafted particles was analyzed by thermogravimetry (TGA). TGA thermogram result indicated the SiO₂-g-PS particles containing 45.1% by weight of grafted polystyrene.

The weight % of grafted polystyrene of the isolated particles is calculated by the equation shown below:

W_{g-ps}%=[1-W_{SiO}_{₂}/(Wₜₒₜₐₗ-Wₛₒₗᵥₑₙₜ)]×100

W_{g-ps} is the grafted polystyrene weight;

Wₜₒₜₐₗ is the original sample weight;

Wₛₒₗᵥₑₙₜ is the solvent/water weight, corresponding to the weight loss prior to 200° C. from the TGA graph;

W_{SiO}_{₂} is the silicon oxide nanoparticles weight, corresponding to the residue weight (>800° C.) from the TGA graph.

### Step B. Sulfonation of the Polystyrene Grafted Silicon Oxide Particles

In a three-neck round-bottom flask (500 mL), 25 g of SiO₂-g-PS particles, obtained from Step A, were dispersed in 250 mL dichloroethane by ultrasonication for 30 minutes. The reaction flask was then connected with a reflux condenser and an addition funnel, then the mixture was heated to 60° C. using an oil bath under N₂.

Acetic anhydride (10.5 mL) and dichloroethane (22 mL) were added to a 250 mL round bottom flask, then cooled to 0° C. with stirring. Concentrated sulfuric acid (95-97%, 5.4 mL) was added dropwise to the reaction mixture. The reaction mixture was stirred until a homogeneous and dear solution of acetyl sulfate was obtained at room temperature (about 3 hours). During the preparation, 2 mL acetic anhydride was used to scavenge any trace of water, if present.

The freshly prepared acetyl sulfate solution was poured into the additional funnel, then added dropwise to the SiO₂-g-PS dispersion. The colorless reaction mixture turned yellow upon the sulfonating agent was added. The addition was complete over 30 minutes and the resulting mixture was maintained at 60° C. with stirring for additional 5 hours. Aliquot of crude product was taken every hour to assess the sulfonation progress by acid-base titration.

The reaction was terminated by adding 2-propanol (7.5 mL) and coded to room temperature with stirring. The resulting crude mixture as well as the 4 samples were centrifuged to isolate the sulfonated SiO₂-g-PS (SiO₂-g-PS-SO₃H) particles, and washed with water, centrifuged for 3 times. The sulfonated particles were dried in vacuum oven at 50° C. for 24 hour to yield the SiO₂-g-PS-SO₃H particles (22 g), modified nanoparticles of the present invention, sample 1 (taken 1 hr after addition completed, 0.7 g), sample 2 (2 hr, 0.6 g) sample 3 (3 hr, 0.5 g), and sample 4 (4 hr, 0.4 g).

The titration was carried out by dispersing about 0.1 g of the dried sample in 20 mL of methanol, then titrated with 0.01 mol/L of NaOH methanol solution. The tests were run in duplicates and the results shown below (Table 1) are average data of the two tests. The results suggested that the sulfonation at 60° C. was completed around 3 hours after completing addition of the sulfonating agent.

TABLE 1

| | | | | | Product of |
|---|---|---|---|---|---|
| Sample ID | Sample 1 | Sample 2 | Sample 3 | Sample 4 | Example 1 |
| Reaction | 1 hr | 2 hr | 3 hr | 4 hr | 5 hr |
| time | | | | | |
| mol of | 0.31 | 0.70 | 0.84 | 0.81 | 0.85 |
| SO₃H/Kg | | | | | |
| of modified | | | | | |
| particles, | | | | | |
| determined | | | | | |
| by titration | | | | | |

Finally, the dried sulfonated particles (21 g) were dispersed in methanol (250 mL) by ultrasonication for 30 minutes, then neutralized with a methanolic solution of NaOH (1.46 g of NaOH in 150 mL) at 40° C. to pH 7. The neutralized particles were centrifuged, decanted, and washed with deionized water for 3 times, then dried at 50° C. for 24 hour to yield the neutralized product, SiO₂-g-PS-SO₃Na particles (20 g), modified nanoparticles of the present invention.

### Examples 2-4

### Preparation of Modified Nanopartides of SiO₂, TiO₂, and ZnO

Examples 2-4 were modified nanoparticles of silicon oxide, titanium oxide and zinc oxide prepared by similar methods described in Example 1. The methods involved first step of grafting polymerization with styrene onto nanoparticles which has 3-methacryloxypropyltrimethoxysilane covalently attached as the grafting point, then followed by sulfonation as the 2^{nd} step, neutralization to obtain the modified nanoparticles of the invention. The amounts of reagents, isolated intermediates, and product yields are listed in Table 2 below.

TABLE 2

| | | |
|---|---|---|
| Example 2 | Example 3 | Example 4 |

Step A. Grafting polymerization

| Nanoparticles | SiO₂ | TiO₂ | ZnO |
|---|---|---|---|
| Grams in 200 ml ethanol | 20 | 20 | 20 |
| Deionized water (mL) | 1900 | 1900 | 1900 |
| 2-propanol (g) | 40 | 40 | 40 |
| sodium dodecyl sulfate (g) | 0.6 | 0.6 | 0.6 |
| OP-10 (g) | 0.3 | 0.3 | 0.3 |
| KPS (g) | 0.2 | 2.0 | 2.0 |
| Styrene (mL) | 200 | 200 | 200 |
| Isolated particle-g-PS | SiO₂-g-PS | TiO₂-g-PS | ZnO-g-PS |
| Amount isolated (g) | 36.8 | 35.5 | 53.0 |
| Weight % of grafted | 60.1 | 53.3 | 86.0 |
| polystyrene | | | |

Step B. Sulfonation of the polystyrene grafted particles

| particle-g-PS | SiO₂-g-PS | TiO₂-g-PS | ZnO-g-PS |
|---|---|---|---|
| Amount of particle-g-PS | 36.0 | 35.0 | 52.0 |
| (g) | | | |
| Dichloroethane (mL) | 144 | 144 | 210 |
| Acetic anhydride (mL) | 10.0 | 11.0 | 25.6 |
| Dichloroethane (mL) | 17.6 | 19.0 | 25.0 |
| conc. sulfuric acid (mL) | 5.5 | 5.0 | 14.8 |
| 2-propanol (mL) | 18 | 18 | 8.2 |
| | SiO₂-g-PS- | TiO₂-g-PS- | ZnO-g-PS- |
| particle-g-PS-SO₃Na | SO₃Na | SO₃Na | SO₃Na |
| Isolated amount (g) | 39.1 | 40.3 | 55.2 |
| mol of SO₃H per Kg of | 1.56 | 1.99 | 0.23 |
| modified particles, | | | |
| determined by EDS | | | |
| stoichiometry ratio | S:Si = 0.34:1 | S:Ti = 2.44:1 | S:Zn = 0.34:1 |

According to the amount specified in Table 3, the ingredients of each working example and ingredients of each comparative example are processed according to the compounding procedure and fiber spinning procedure, and dyeing procedure described below, and tested using general testing methods.

### Compounding Procedure for Working Examples 5-12 and Comparative Examples 1-2

Prior to compounding, the PTT pellets were dried at 120° C. for about 12 hours in a forced air-circulating oven and the modified nanoparticles of this invention were dried in a vacuum oven at 50° C. for 24 hour.

The ingredients of each example with amounts specified according to Table 3 were fed to a twin screw extruder (Eurolab 16) to obtain the corresponding nanocomposite composition as pellets.

a) Examples 5, 6 (E5, E6) and comparative example 1 (CE1)
The temperature of the extruder was set to be 250/250/250/250/250/250/250/250/250/250° C. for the extruder of 10 heating block configuration. The die temperature was 250° C. and the screw speed was at 200 rpm with a throughput of 2.5 Kg/hour.

b) Examples 7-12 (E7-E12) and comparative example 2 (CE2)
The temperature of the extruder was set to be 50/210/220/230/235/235/240/240/245/245° C. for the extruder of 10 heating block configuration. The die temperature was 245° C. and the screw speed was at 350 rpm with a throughput of 4 Kg/hour.

TABLE 3

| Materials | CE1 | E5 | E6 | CE2 | E7 | E8 | E9 | E10 | E11 | E12 |
|---|---|---|---|---|---|---|---|---|---|---|
| PTT (g) | 1494 | 690.2 | 585.6 | 996 | 788.8 | 780.8 | 788.8 | 780.8 | 788.8 | 780.8 |
| IRGANOX ® | 6 | 2.8 | 2.4 | 4 | 3.2 | 3.2 | 3.2 | 3.2 | 3.2 | 3.2 |
| 1010, (g) | | | | | | | | | | |
| Modified | None | SiO₂-g-PS- | | None | SiO₂-g-PS- | | TiO₂-g-PS- | | ZnO-g-PS- | |
| particle | | SO₃Na of | | | SO₃Na of | | SO₃Na of | | SO₃Na of | |
| | | Example 1 | | | Example 2 | | Example 4 | | Example 5 | |
| Amount (g) | 0 | 7 | 0 | 0 | 8 | 16 | 8 | 16 | 8 | 16 |
| Total (g) | 1500 | 700 | 600 | 1000 | 800 | 800 | 800 | 800 | 800 | 800 |
| Weight % | 0 | 1 | 2 | 0 | 1 | 2 | 1 | 2 | 1 | 2 |
| of modified | | | | | | | | | | |
| nanoparticles | | | | | | | | | | |

### General Melt Spinning Procedure

The fibrous substrates (Le. yarns) of the present invention were obtained by the melt-spinning process using a Fuji E0200 and a Fujifilter

MST C400 melt spinning machine (Japan). The pellets obtained from the compounding procedure described above (about 100 g) which were dried at 130° C. for 12 hours before being spun. To the dried pellets were extruded from a 28 holes-spinneret pack (diameter=0.5 mm, length/diameter=2) with a melt extrusion rate of 6 mL/min and a spinning temperature of 255° C., the fibers were wound at a speed of 400 m/min to obtain partially drawn yarns for each example. The pellets of the control example (i.e. Semidull Sorona® having no modified nanoparticles of the present invention) were melt-spun using the same parameters.

### General Dyeing Procedure

The cationic dye used for evaluation was Astrazon Red GTLN micro 200%, which was supplied by Dystar Co.

The dye solution was prepared by dissolving the dye (1 g), doedecyldimethyl benzyl ammonium chloride (0.5 g) as leveling agent, sodium sulfate (4 g) to improve the brilliance of the dyed product, sodium acetate (1 g) in deionized water (93.5 g); adding acetic acid (98% purity, about 5 mL) to adjust the pH to 4.1-4.2; followed by diluting with deionized water to 1 L to obtain the dye solution (0.1 weight %). The dye bath ratio was 1 g fiber: 100 g of dye solution. The dyeing was performed using MATHIS beaker dyeing apparatus under atmospheric pressure. The dyeing temperature was programmed to heat from room temperature to 45° C. at a rate of 3° C./min, hold for 5 min, heated to 100° C. at a rate of 1° C./min, hold for 60 min, then cool to 60° C. at a rate of 3° C./min. The dyed fibers were then washed with 150 mL of a 1% sodium hydroxide solution (pH 9) for 3 times to remove unbound dye, then rinsed with tap water and air-dried.

The reflectance of the dyed samples was measured by a Color® Primer 8000 spectrophotometer and the measured values of CIELab (L*, a*, b*) were listed in Table 4. L* is the lightness of the color, where 0 is black and 100 is white. Positive values of a* mean red color. Positive values of b* mean yellow color. Negative values of b* mean blue color. Negative values of ΔL* indicate that the sample color is darker than the control. For samples dyed with red dye, positive values of Δa* indicate that the sample has a deeper red color than the control.

TABLE 4

| | Dye | | | | | | |
|---|---|---|---|---|---|---|---|
| Sample ID | color | L* | a* | b* | ΔL* | Δa* | Δb* |
| CE1, Control | Red | 61.0 | 25.0 | 18.1 | — | — | — |
| E5 (1% of SiO₂-g- | | 56.3 | 26.7 | 20.3 | −4.7 | 1.7 | 2.2 |
| PS-SO₃Na from E1) | | | | | | | |
| E6 (2% of SiO₂-g- | | 55.2 | 27.6 | 19.4 | −5.8 | 2.6 | 1.3 |
| PS-SO₃N from E1) | | | | | | | |

From the results of Table 4, the following are evident.

From the comparison of a* values between Examples 6 and 7 and the control, CE1, it can be seen that the fibrous substrates spun from polyester compositions (i.e. PTT) containing 1 or 2 weight % of the modified nanoparticles of the present invention (i.e. SiO₂-g-PS-SO₃Na) provided increasing cationic dyeability. In addition, the dyeability enhancement corresponds to the amount of the modified nanoparticles the polyester compositions.

While the invention has been illustrated and described in typical embodiments, it is not intended to be limited to the details shown, since various modifications and substitutions are possible without departing from the spirit of the present invention. As such, modifications and equivalents of the invention herein disclosed may occur to persons skilled in the art using no more than routine experimentation, and all such modifications and equivalents are believed to be within the spirit and scope of the invention as defined b the following claims.

What is claimed is:

1. Modified nanoparticles comprising nanoparticles grafted with at least one polymer, wherein the polymer comprises at least one sulfonated benzene group; the nanoparticles prior to being grafted with the polymer has an average diameter of about 100 nm or less; and the weight % of the at least one polymer ranges from about 30 weight % to about 90 weight %, based on the total weight of the modified nanoparticles.

2. The modified nanoparticles of claim 1, wherein the nanoparticles are selected from the group consisting of silicon oxide, metal oxides, metal carbonates, and combinations thereof.

3. The modified nanoparticles of claim 2, wherein the nanoparticles are selected from the group consisting of SiO₂, TiO₂, ZnO, CaCO₃, MgCO₃ and combinations thereof.

4. The modified nanoparticles of claim 3, wherein the nanoparticles are selected from the group consisting of SiO₂, TiO₂, ZnO and combinations thereof.

5. The modified nanoparticles of claim 1, wherein the nanoparticles are treated with organosilanes selected from the group consisting of 3-methacryloxypropyltrimethoxy-silane, 3-acryloxypropyltrimethoxysilane, 3-methacryloxypropyltriethoxysilane, 3-acryloxy-propyltriethoxysilane, 3-glycidyloxypropyltrimethoxysilane, and 3-glycidyloxypropyl-triethoxysilane.

6. The modified nanoparticles of claim 1, wherein the at least one polymer is derived from aromatic vinyl monomers and comprising at least one sulfonated benzene group.

7. The modified nanoparticles of claim 6, wherein the aromatic vinyl monomers are selected from styrene, □-methylstyrene, □-methylstyrene, o-methylstyrene, m-methylstyrene, p-methylstyrene, o-ethylstyrene, m-ethylstyrene, p-ethylstyrene, o-tert-butylstyrene, m-tert-butylstyrene, p-tert-butylstyrene, o-chlorostyrene, m-chlorostyrene, p-chlorostyrene, dichlorostyrene, o-bromostyrene, m-bromostyrene, p-bromostyrene, dibromostyrene, vinyl toluene, vinyl xylene, vinyl naphthalene, divinylbenzene, sodium 4-ethenylbenzenesulfonate, potassium 4-ethenylbenzenesulfonate, sodium 4-ethenyl-3-ethylbenzenesulfonate, potassium 4-ethenyl-3-ethylbenzenesulfonate, and combinations thereof.

8. The modified nanoparticles of claim 7, wherein the at least one polymer is sulfonated polystyrenes.

9. A nanocomposite composition comprising the modified nanoparticles of claim 1.

10. The nanocomposite composition of claim 9, wherein the amount of the modified nanoparticles of claim 1 ranges from about 0.1 weight % to about 10.0 wt % based on the total weight of the nanocomposite composition.

11. The nanocomposite composition of claim 9 further comprising polyesters, wherein the polyesters are selected from polyethylene terephthalates, polytrimethylene terephthalates, polybutylene terephthalates, and combinations thereof.

12. A fibrous substrate comprising the nanocomposite composition of claim 9.

13. The fibrous substrate of claim 12 is yarns, fabrics, textiles, or carpets.

14. Use of the nanocomposite composition of claim 9 to make a fibrous substrate having improved cationic dyeability, wherein the amount of the modified nanoparticles of claim 1 ranges from about 0.1 weight % to about 10.0 wt % based on the total weight of the nanocomposite composition.

15. A method for preparing the modified nanoparticle of claim 1 comprising:
(a) providing nanoparticles having an average diameter of about 100 nm or less, and containing at least one epoxy, acrylate, or methacrylate group covalently bonded on the surface of nanoparticles;
(b) treating the nanoparticles of (a) with aromatic vinyl monomers which may or may not substituted with sulfonate group in the presence of a polymerization initiator to obtain polymer-grafted nanoparticles;
(c) treating the polymer-grafted nanoparticles of (b) with a sulfonating agent at 25-100° C. for 2-24 hours to obtain modified nanoparticles comprising at least one sulfonated benzene group;
(d) optionally, neutralizing the modified nanoparticles with base; and
(e) drying the modified nanoparticles in an oven at 25-100° C. for 6-24 hours.

16. A fibrous substrate comprising the nanocomposite composition of claim 11.
